(19) United States
(12) Patent Application Publication
(10) Pub. No.: US 2012/0069113 A1
(43) Pub. Date: Mar. 22, 2012

(54) IMAGE FORMING APPARATUS, MEDIUM PROCESSING APPARATUS, AND IMAGE FORMING METHOD

(75) Inventors: Yoshiaki Kaneko, Shizuoka-ken (JP); Hirofumi Kondo, Kanagawa-ken (JP); Masahiro Doi, Shizuoka-ken (JP); Satoshi Kaiho, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/232,748

(22) Filed: Sep. 14, 2011

Related U.S. Application Data
(60) Provisional application No. 61/384,066, filed on Sep. 17, 2010.

(51) Int. Cl. B41J 2/01

(52) U.S. Cl. 347/104

(57) ABSTRACT

According to one embodiment, an image forming apparatus includes a retaining roller, a triboelectric charging device, and an inkjet head. The retaining roller includes a first charging section including a first dielectric and a second charging section including a second dielectric, which have different triboelectric charging characteristics, alternately on the surface of the retaining roller, retains a recording medium on the surface, and rotates. The triboelectric charging device charges the surface of the retaining roller by friction. The inkjet head forms an image on the recording medium retained on the surface of the retaining roller.

### CROSS-REFERENCE TO RELATED APPLICATIONS

This application claims the benefit of U.S. Provisional Application No. 61/384,066 filed on Sep. 17, 2010.

### FIELD

Embodiments described herein relate generally to an image forming apparatus, a medium processing apparatus, and an image forming method.

### BACKGROUND

As the image forming apparatus, there is an image forming apparatus that rotates a retaining roller with a recording medium such as a sheet retained on the surface thereof to thereby convey the recording medium along the outer circumference of the retaining roller and performs image formation on the recording medium in an image forming section provided in the outer circumferential section of the retaining roller. In this image forming apparatus, for example, the recording medium is pressed against and closely attached to the surface of the retaining roller by a retaining device including a pressing mechanism and an attraction mechanism and is attracted to the surface of the retaining roller with electrostatic force, whereby the recording medium is retained on the surface of the retaining roller.

As a general attraction mechanism, a charging roller or a charger is used to apply a voltage to the retaining roller to thereby generate electrostatic force in the outer circumferential section of the retaining roller and attract the recording medium. In such an attraction mechanism, since it is necessary to apply a voltage of several kilowatts for generation of electrostatic force, power consumption increases.

### BRIEF DESCRIPTION OF THE DRAWINGS

FIG. 1 is a side view of the configuration of an image forming apparatus according to an embodiment;

FIG. 2 is a sectional view of the configuration of a dielectric layer of a retaining roller of the image forming apparatus according to the embodiment;

FIG. 3 is a side view of the configuration of the retaining roller of the image forming apparatus according to the embodiment;

FIG. 4 is a block diagram of a system configuration of the image forming apparatus according to the embodiment;

FIG. 5 is a flowchart for explaining the operation of the image forming apparatus according to the embodiment;

FIG. 6 is a side view of the configuration of a retaining roller of an image forming apparatus according to another embodiment; and

FIG. 7 is a table of an example of combination of a first dielectric and a second dielectric.

### DETAILED DESCRIPTION

In general, according to one embodiment, an image forming apparatus includes a retaining roller, a triboelectric charging device, and an inkjet head. The retaining roller includes a first charging section including a first dielectric and a second charging section including a second dielectric, which have different triboelectric charging characteristics, alternately on the surface of the retaining roller, retains a recording medium on the surface, and rotates. The triboelectric charging device charges the surface of the retaining roller by friction. The inkjet head forms an image on the recording medium retained on the surface of the retaining roller.

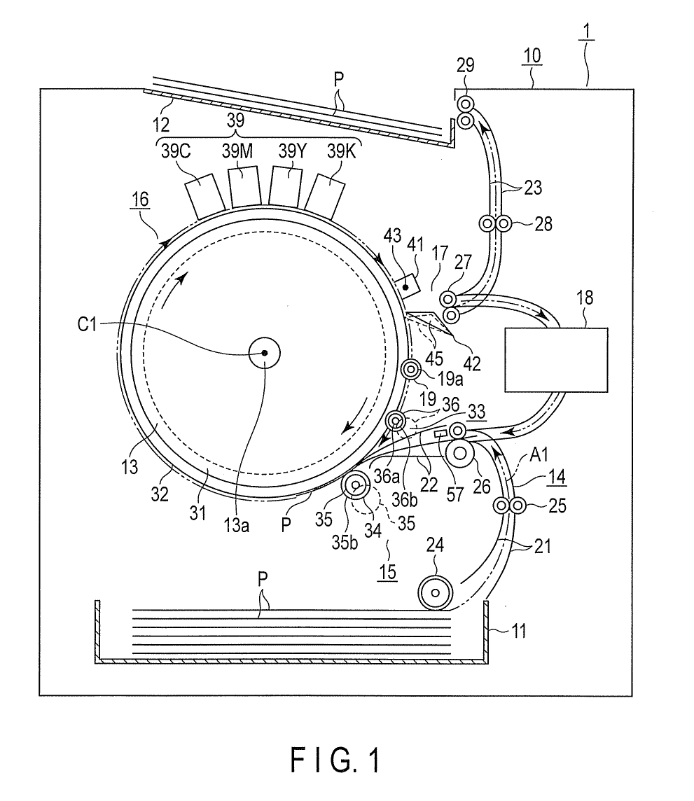

An image forming apparatus (a medium processing apparatus) 1 according to an embodiment is explained. In the figures, components are expanded, reduced, or omitted as appropriate to schematically show the components. FIG. 1 is a side view of a mechanism of the image forming apparatus 1 according to this embodiment.

The image forming apparatus 1 shown in FIG. 1 is, for example, an apparatus that performs various kinds of processing such as image formation while conveying a sheet P, which is a recording medium. The image forming apparatus 1 is, for example, an inkjet recording apparatus and includes a housing 10 that forms an outer hull, a paper feeding cassette 11 functioning as a sheet feeding section provided on the inside of the housing 10, a paper discharge tray 12 functioning as a discharge section provided in an upper part of the housing 10, an image forming section 16 including a retaining roller (a drum) 13 configured to retain the sheet P on the outer surface thereof and rotate, a reversing device 18 configured to reverse the front and rear surfaces of the sheet P peeled off the drum 13 and feed the sheet P onto the surface of the drum 13 again, and a conveying device 14 configured to convey the sheet P along conveying paths A1 and A2 from the paper feeding cassette 11 to the drum 13 and from the drum 13 to the discharge section.

The conveying device 14 includes plural guide members 21 to 23 provided along the conveying path A1 and plural conveying rollers 24 to 29 provided along the conveying path A2. As the conveying rollers, a pickup roller 24, a paper feeding roller pair 25, a registration roller pair 26, a separating roller pair 27, a conveying roller pair 28, and a discharge roller pair 29 are provided. A sheet position sensor 57 configured to detect the leading end position of the sheet P is provided near a nip of the registration roller pair 26 in the conveying path A1.

The image forming section 16 includes, besides the drum 13, in order from an upstream side to a downstream side starting from a position where a guide member 22 and the drum 13 are in close contact with each other in the outer circumferential section of the drum 13, a pressing device 34 configured to press the sheet P against the drum 13, an inkjet head unit 39 configured to form an image on the sheet P retained on the outer surface of the drum 13, an electricity removing and peeling device 17 configured to remove electricity of the sheet P and peel the sheet P off the drum 13, a cleaning device 19 configured to clean the drum 13, and a triboelectric charging device 33 configured to charge the surface of the drum 13 by friction. The triboelectric charging device 33 is arranged near the position where the guide member 22 and the drum 13 are in close contact with each other. No other devices are arranged between the triboelectric charging device 33 and the position. In other words, the triboelectric charging device 33 is located most downstream on the outer circumference of the drum 13 with respect to a position where the sheet P reaches the drum 13.

The drum 13 includes a rotating shaft 13a, a cylindrical frame 31 formed of aluminum, which is a conductor, in a cylindrical shape, and a thin dielectric layer 32 formed on the surface of the cylindrical frame 31. The drum 13 is formed in a cylindrical shape having fixed length in an axis direction.

The triboelectric charging device 33 includes a friction bar 36 arranged to be opposed to the surface of the drum 13 and a friction motor 73 explained later configured to drive the friction bar 36. The friction bar 36 includes a friction shaft 36a of metal extending in parallel to the rotating shaft 13a and a surface layer section 36b formed on the outer circumference of the friction shaft 36a and forming a surface.

For example, in a triboelectric charging series, the surface layer section 36b is located in the middle between a first dielectric and a second dielectric and formed of a material that makes it possible to charge the first dielectric to positive polarity and charge the second dielectric to negative polarity. In this embodiment, the material of the surface layer section 36b is rubber.

The friction bar 36 can be moved in a direction in which the friction bar 36 approaches and separates from the surface of the drum 13 according to the driving of the friction motor 73. The friction bar 36 can be switched, according to the position of the friction bar 36, between a contact state in which the friction bar 36 comes into contact with the surface of the drum 13 as indicated by a solid line in FIG. 1 and a non-contact state in which the friction bar 36 separates and retracts from the drum 13 as indicated by a broken line in FIG. 1.

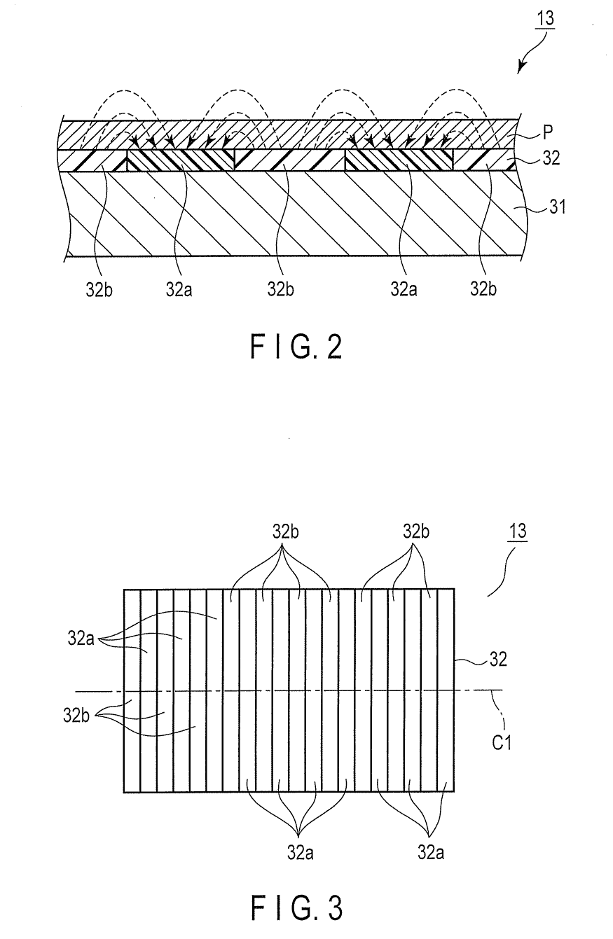

If the drum 13 rotates in a state in which the friction bar 36 is in contact with the drum 13, friction occurs on the surface of the dielectric layer 32. As shown in FIG. 2, first charging sections 32a are charged to positive polarity and second charging sections 32b are charged to negative polarity. A potential difference between the first charging sections 32a and the second charging sections 32b occurs. Electric lines of force directed from the first charging sections 32a to the second charging sections 32b are generated by the potential difference as indicated by broken lines in FIG. 2 and electric fields are formed. The sheet P is attracted to and retained on the drum 13 by electrostatic force directed to the drum 13 of the electric fields.

The pressing device 34 includes a pressing roller 35 (a pressing member) arranged to be opposed to the surface of the drum 13 and a pressing motor 14 explained later configured to drive the pressing roller 35. The outer circumferential surface of the pressing roller 35 is covered with an insulating layer 35b made of an insulating material to prevent charges of the charged sheet P from leaking through the pressing roller 35.

The guide member 22 is present between the triboelectric charging device 33 and the pressing device 34.

As shown in FIG. 1, the pressing roller 35 configured to be movable in plural stages in the radial direction of the drum 13 by the pressing motor 74 can be switched, according to the position of the pressing roller 35, between a pressing state in which the pressing roller 35 presses the surface of the drum 13 with first pressing force as indicated by a solid line in FIG. 1 and a release state in which the pressing roller 35 separates from the drum 13 and the pressing force is released as indicated by a broken line in FIG. 1.

A load applied between the pressing roller 35 and the drum 13 is set to a proper value with which the sheet P is not deformed and image quality is not deteriorated. When the sheet P passes a nip between the drum 13 and the pressing roller 35, the sheet P is pressed against the drum 13 by the pressing roller 35, whereby the sheet P adheres to the surface of the drum 13 while creases of the sheet P are smoothed.

The inkjet head unit 39 includes plural inkjet heads 39c, 39m, 39y, and 39b. The inkjet heads 39c, 39m, 39y, and 39b for four colors of cyan, magenta, yellow, and black are respectively provided. The inkjet heads 39c, 39m, 39y, and 39b for the four colors eject inks to the sheet P from nozzles provided at a predetermined pitch to form an image.

The electricity removing and peeling device 17 includes an electricity removing device 41 configured to remove electricity of the sheet P and a peeling device 42 configured to peel the sheet P off the surface of the drum 13 after the electricity removal.

The electricity removing device 41 includes a chargeable wire (a corona charger) 43. The electricity removing device 41 supplies charges to the sheet P to remove electricity of the sheet P to release attraction force and make it easy to peel the sheet P off the drum 13.

The peeling device 42 includes a pivotable (movable) separation claw 45. The separation claw 45 can pivot between a peeling position where the separation claw 45 is inserted between the sheet P and the drum 13 and a retraction position where the separation claw 45 retracts from the drum 13. In a state in which the separation claw 45 is arranged in the peeling position, the separation claw 45 peels the sheet P off the surface of the drum 13. In FIG. 1, the state in which the separation claw 45 is present in the peeling position is indicated by a broken line and a state in which the separation claw 45 is present in the retracted position is indicated by a solid line.

The cleaning device 19 is provided further on the downstream side than the peeling device 17 with respect to the position where the guide member 22 and the drum 13 are in close contact with each other.

The reversing device 18 is provided between the conveying path A1 and the conveying path A2. The reversing device 18 reverses the sheet P peeled by the peeling device 42 and feeds the sheet P onto the surface of the drum 13 again. As the reversing device 18, any publicly-known mechanism such as a mechanism for switching back the sheet P to be reversed in a front-back direction may be used.

FIG. 2 is a sectional view of the dielectric layer 32 of the drum 13 and FIG. 3 is a side view of the drum 13. As shown in FIGS. 2 and 3, in the dielectric layer 32, the first charging sections 32a including a first dielectric as a positive polarity material and the second charging sections 32b including a second dielectric having a triboelectric charging characteristic different from that of the first dielectric are alternately arranged in a stripe shape in parallel in the axis direction of the drum 13. A width dimension in the parallel arrangement direction of the first charging sections 32a and the second charging sections 32b is set to, for example, 1 cm to 10 cm. In other words, on the surface of the drum 13, the first charging sections 32a and the second charging sections 32b are alternately provided in a stripe shape in a direction orthogonal to an axis C1.

The first charging sections 32a are formed of the first dielectric as the positive polarity material. The second charging sections 32b are formed of the second dielectric as the negative polarity material that is easily charged to the negative side. The first dielectric and the second dielectric are materials present in different orders on a triboelectric charging series and have different triboelectric charging characteristics. The first dielectric and the second dielectric are formed of, for example, fluoric, acrylic, or polyethylene insulative synthetic resin. In this embodiment, the first dielectric as the positive polarity material is nylon and the second dielectric as the negative polarity material is PTFE (polytetrafluoroethylene).

Since the first charging sections 32a and the second charging sections 32b are alternately provided in a stripe shape at predetermined width, as shown in FIG. 2, electric fields are formed from the second charging sections 32b to the first charging sections 32a. Consequently, electrostatic attraction force is generated and the sheet P can be attracted to the drum 13.

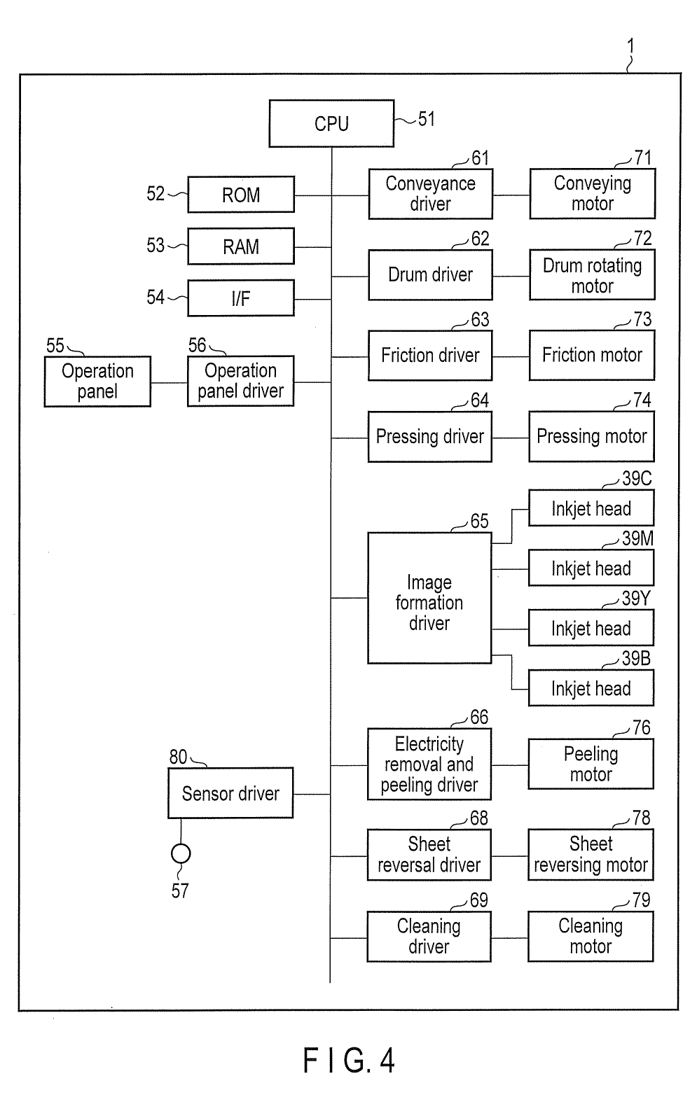

As shown in FIG. 4, the image forming apparatus 1 includes a CPU (central processing unit) 51, which is a controller, a ROM (read only memory) 52 having stored therein various computer programs and the like, a RAM (random access memory) 53 configured to temporarily store various variable data, image data, and the like, and an interface (I/F) 54 configured to receive input of data from the outside and output data to the outside.

The image forming apparatus 1 includes a conveying motor driver 61 configured to control a conveying roller motor 71 coupled to the rollers 24 to 29 functioning as conveying rollers, a drum driver 62 configured to control a drum rotating motor 72 coupled to the drum 13, a friction control driver 63 configured to control the friction motor 73 coupled to the friction bar 36, a pressing motor driver 64 configured to control the pressing motor 74 coupled to the pressing roller 34, an image formation driver 65 configured to control the inkjet heads 39c, 39m, 39y, and 39b, an electricity removal and peeling driver 66 configured to control a peeling motor 76 connected to the electricity removing device 41 configured to remove electricity of the sheet P and connected to the separation claw 45, a sheet reversal control driving circuit (driver) 68 configured to control a sheet reversing motor 78 coupled to the reversing device 18, a cleaning control driving circuit (driver) 69 configured to control a cleaning motor 79 coupled to a cleaning member 19a, a sensor control driving circuit (driver) 80 configured to control the sensor 57 and the like, and an operation panel control driving circuit (driver) 56 configured to control an operation panel 55.

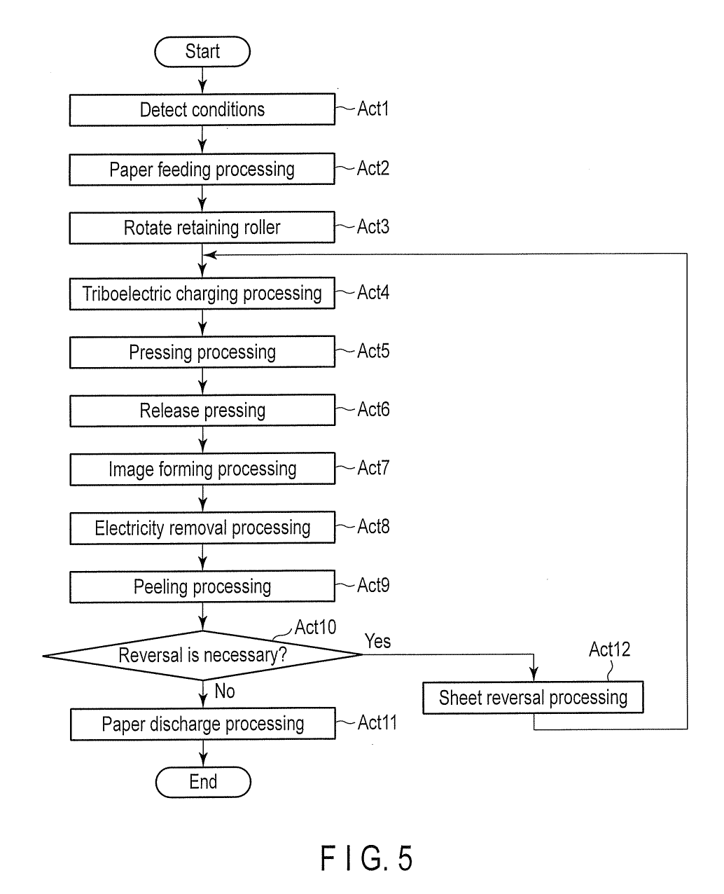

Actions of the image forming apparatus 1 according to this embodiment are explained below with reference to a flowchart of FIG. 5.

First, the CPU 51 detects various conditions (Act 1). The conditions are, besides necessity of duplex printing, for example, a printing ratio, a color, printing speed, the resolution of image formation, and the thickness of the sheet P. The CPU 51 detects these conditions from information detected by the sensor 57 or information input from the interface 54. For example, the CPU 51 detects conditions such as the thickness of the sheet P, a printing mode of duplex printing or simplex printing, the resolution of image formation, and a color mode via the interface 54 on the basis of, for example, a setting input by a user. The CPU 51 determines conditions such as a printing ratio, a color, and printing speed on the basis of information concerning an image to be printed and information such as resolution. Besides, the CPU 51 detects conditions such as the position of the sheet P with the sensor 57.

Subsequently, the CPU 51 performs paper feeding processing (Act 2). In the paper feeding processing, the CPU 51 feeds one sheet P along the conveying path A1 out of a sheet bundle stacked on the paper feeding cassette 11.

At predetermined timing, the CPU 51 instructs the drum control driving circuit (driver) 62 to rotate the drum 13 (Act 3).

At predetermined timing before the sheet P is supplied onto the surface of the drum 13, the CPU 51 instructs the friction control driving circuit (driver) 63 to bring the friction bar 33 into contact with the surface of the drum 13 at predetermined pressure (Act 4).

If the position of the friction bar 36 is set in a contact position and the drum 13 rotates in the contact state, the surface of the drum 13 is rubbed by the friction bar 36. The first charging sections 32a and the second charging sections 32b on the surface of the drum 13 are respectively charged to positive and negative and electrostatic force is generated. The triboelectric charging device 33 is located most downstream with respect to the position where the guide member 22 and the drum 13 are in close contact with each other. Therefore, it is possible to surely attract the sheet P to the drum 13 when the sheet P reaches the drum 13.

At predetermined timing before the sheet P reaches the nip between the pressing roller 35 and the drum 13, the CPU 51 instructs the pressing motor control driving circuit (driver) 64 to cause the pressing roller 35 to press the drum 13 (Act 5).

At predetermined timing when the trailing end of the sheet P moves further to the downstream side than the pressing roller 35, the CPU 51 instructs the pressing motor control driving circuit 64 to retract the pressing roller 35 (Act 6).

The CPU 51 performs image forming processing (Act 7). In the image forming processing, the CPU 51 instructs the image formation control driving circuit (driver) 65 to cause the inkjet heads 39c, 39m, 39y, and 39b to eject inks to the surface of the sheet P and perform printing. At this point, the CPU 51 performs image formation according to various conditions such as resolution and a printing mode.

After the end of the image forming processing, the CPU 51 starts the electricity removing device 41 (Act 8) to thereby remove electricity of the sheet P and release electrostatic attraction force. The CPU 51 drives the peeling device 42 on the downstream side (Act 9) to thereby peel the sheet P off the surface of the drum 13.

The CPU 51 determines whether a reversal of the sheet P is necessary (Act 10). If the CPU 51 determines that the reversal of the sheet P is unnecessary (NO in Act 10), paper discharge processing is performed (Act 11).

On the other hand, if the CPU 51 determines that the reversal of the sheet P is necessary (YES in Act 10), the CPU 51 instructs the reversing device 18 to perform reversal processing (Act 12). As the reversal processing, processing for guiding, through switching of the separating roller 27, the sheet P to the conveying path A1 leading to the reversing device 18 and reversing the front and rear surfaces of the sheet P with the reversing device 18 is performed. The reversing device 18 reverses the front and rear surfaces of the sheet P by, for example, temporarily storing the sheet P and guiding, from the trailing end, the sheet P to a reversing path for switching back the sheet P.

After the reversal processing, the CPU 51 returns to Act 4. The CPU 51 performs the processing in Acts 4 to 10 again. After the reversal processing, the rear surface of the sheet P is faced to the outer side. After the image forming processing on the rear surface ends, since the reversal is unnecessary, the CPU 51 determines that the reversal is unnecessary (NO in Act 10) and performs the paper discharge processing (Act 11).

After the sheet P is peeled, the surface of the drum 13 is cleaned by the cleaning member 19 provided further on the downstream side. The drum 13 rotates in a state in which the drum 13 is in contact with the cleaning member 19, whereby the cleaning member 19 cleans the surface of the drum 13.

With the image forming apparatus 1 according to this embodiment, since the plural charging sections having different triboelectric charging characteristics are provided on the surface of the drum 13, attraction force can be generated by triboelectric charging. Therefore, since voltage application for generating static electricity is unnecessary, power consumption can be reduced.

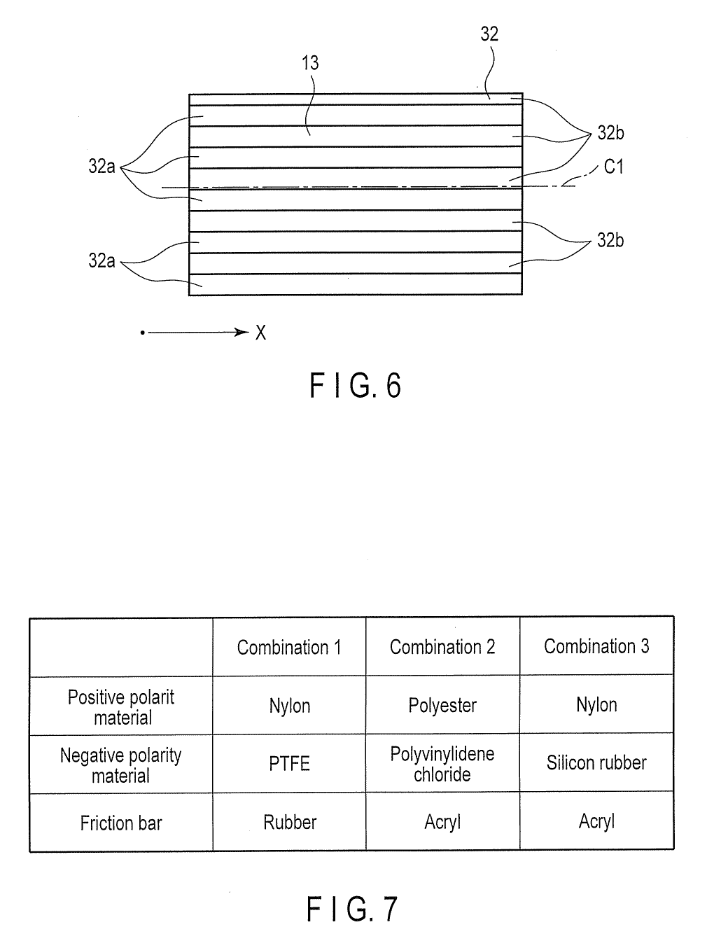

The present invention is not limited to the embodiment and can be modified as appropriate. In the example explained in the embodiment, the first charging sections 32a and the second charging sections 32b are alternately arranged in parallel in the direction of the axis C1 of the drum 13. However, the present invention is not limited to this. For example, as another embodiment, as shown in FIG. 6, even if the first charging sections 32a and the second charging sections 32b are alternately arranged in parallel in the circumferential direction of the drum 13, effects same as those in the embodiment can be obtained.

In the example explained in the embodiment, the first dielectric is nylon, the second dielectric is PTFE (polytetrafluoroethylene), and the material of the friction bar 36 is rubber. However, the present invention is not limited to this. For example, as another embodiment, the first dielectric may be polyester, the second dielectric may be polyvinylidene chloride, and the material of the friction bar 36 may be acryl as indicated by a combination example 2 shown in FIG. 7. As still another embodiment, the first dielectric may be nylon, the second dielectric may be silicon rubber, and the material of the friction bar 36 may be acryl as indicated by a combination example 3 shown in FIG. 7. Besides, the first dielectric, the second dielectric, and the friction bar 36 can be formed of various materials.

In the embodiment, the first charging sections 32a and the second charging sections 32b are alternately arranged in a stripe shape over the entire surface of the drum 13. However, the first charging sections 32a and the second charging sections 32b may be arranged only in a part of the surface of the drum 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a retaining roller configured to include a first charging section including a first dielectric and a second charging section including a second dielectric, which have different triboelectric charging characteristics, alternately on a surface of the retaining roller, retain a recording medium on the surface, and rotate;
a triboelectric charging device configured to charge the surface of the retaining roller by friction; and
an inkjet head configured to form an image on the recording medium retained on the surface of the retaining roller.

2. The apparatus according to claim 1, wherein the first charging section and the second charging section are alternately arranged in a direction orthogonal to a rotating shaft of the retaining roller.

3. The apparatus according to claim 1, wherein the triboelectric charging device includes a friction bar arranged to be opposed to the surface of the retaining roller and configured to come into contact with the surface of the retaining roller and charge the surface of the retaining roller by friction.

4. The apparatus according to claim 3, wherein an axis of the friction bar is parallel to the rotating shaft of the retaining roller.

5. The apparatus according to claim 1, wherein the triboelectric charging device is arranged near a region where the recording medium reaches the retaining roller according to paper feeding.

6. The apparatus according to claim 1, wherein the first dielectric is nylon and the second dielectric is PTFE (polytetrafluoroethylene).

7. The apparatus according to claim 6, wherein the triboelectric charging device includes a friction bar arranged to be opposed to the surface of the retaining roller and a surface of the friction bar is formed of a material containing rubber.

8. The apparatus according to claim 1, wherein the first dielectric is polyester and the second dielectric is polyvinylidene chloride.

9. The apparatus according to claim 8, wherein the triboelectric charging device includes a friction bar arranged to be opposed to the surface of the retaining roller and a surface of the friction bar is formed of a material containing acryl.

10. The apparatus according to claim 1, wherein the first dielectric is nylon and the second dielectric is silicon rubber.

11. The apparatus according to claim 10, wherein the triboelectric charging device includes a friction bar arranged to be opposed to the surface of the retaining roller and a surface of the friction bar is formed of a material containing acryl.

12. The apparatus according to claim 1, wherein a width dimension in a parallel arrangement direction of the charging sections is 1 to 10 cm.

13. The apparatus according to claim 1, further comprising a pressing device provided in an outer circumferential section of the retaining roller and on a downstream side of the triboelectric charging device and configured to press the recording medium against the retaining roller.

14. The apparatus according to claim 1, wherein, on the surface of the retaining roller, the first charging section and the second charging section are alternately arranged in parallel in a circumferential direction of the retaining roller.

15. The apparatus according to claim 1, wherein the retaining roller is a cylindrical drum.

16. A medium processing apparatus comprising:
a retaining roller configured to include, in turn, plural charging sections including dielectrics, which have different triboelectric charging characteristics, on a surface of the retaining roller, retain a medium on the surface, and rotate; and
a triboelectric charging device configured to charge the surface of the retaining roller by friction.

17. The apparatus according to claim 16, wherein the triboelectric charging device is arranged near a region where the recording medium reaches the retaining roller according to paper feeding.

18. An image forming method comprising:
charging, by friction, a surface of a retaining roller configured to include plural charging sections including dielectrics, which have different triboelectric charging characteristics, on a surface of the retaining roller and rotate;
pressing a recording medium against the surface of the retaining roller and retain the recording medium; and
forming an image on the recording medium retained on the retaining roller.

19. The method according to claim 18, wherein the plural charging sections are arranged in turn in a direction orthogonal to a rotating shaft of the retaining roller.

20. The method according to claim 18, wherein electricity of the recording medium is removed after the image formation.
